(19) United States
(12) Patent Application Publication
(10) Pub. No.: US 2014/0185904 A1
(43) Pub. Date: Jul. 3, 2014

(54) IMAGE PROCESSING APPARATUS AND IMAGE PROCESSING METHOD

(71) Applicant: CANON KABUSHIKI KAISHA, Tokyo (JP)

(72) Inventor: Keiko Yonezawa, Kawasaki-shi (JP)

(73) Assignee: CANON KABUSHIKI KAISHA, Tokyo (JP)

(21) Appl. No.: 14/135,732

(22) Filed: Dec. 20, 2013

(30) Foreign Application Priority Data
Dec. 28, 2012 (JP) 2012-288357

(51) Int. Cl. G06T 7/00; G06K 9/00

(52) U.S. Cl. CPC G06T 7/004; G06T 7/0012; G06K 9/00604
USPC 382/133

(57) ABSTRACT

Provided is an image processing apparatus to easily identify an image acquiring position of an image by an adaptive optics SLO. The image processing apparatus analyzes an image of an eye to be inspected shot by an adaptive optics SLO, and includes a frequency conversion portion to frequency-convert the image to acquire a frequency spatial image; a characteristic extracting portion to extract a characteristic amount from the frequency spatial image, the characteristic amount relating to a ring-structure reflecting arrangement of photoreceptor cells; and a position estimating portion to estimate an image acquiring position of the image based on the characteristic amount.

### BACKGROUND OF THE INVENTION

1. Field of the Invention

The present invention relates to an image processing apparatus and an image processing method, and particularly relates to an image processing apparatus and an image processing method that are used for ophthalmic medical care and the like.

2. Description of the Related Art

For the purpose of early diagnosis of lifestyle-related diseases or major diseases causing blindness, fundus examination has been widely performed. A scanning laser ophthalmoscope (SLO), which is an ophthalmologic apparatus based on the principle of a confocal laser scanning ophthalmoscope, is configured to perform raster scanning of a laser as measuring light on the fundus and acquire a high-resolution planar image of the fundus quickly based on the intensity of the return light. Adaptive optics SLOs have been recently developed, which is provided with an adaptive optics system to measure aberrations of the eye to be inspected with a wavefront sensor in real time and correct aberrations of measuring light generated at the eye and return light thereof with a wavefront correction device, thus enabling the acquisition of a planar image with a high lateral resolution. A further attempt has been made to extract photoreceptor cells at a retina from an acquired planar image of the retina and to diagnose a disease or evaluate drag response based on the analysis of the density or the distribution of the photoreceptor cells.

“Kaccie Y. Li and Austin Roorda, “Automated identification of cone photoreceptors in adaptive optics retinal images” J. Opt. Soc. Am. A, May 2007, Vol. 24, No. 5, 1358″ discloses an ophthalmic photography apparatus to automatically extract photoreceptor cells from a planar image of a retina acquired using an adaptive optics SLO. This ophthalmic photography apparatus shoots a planar image of a retina with a high lateral resolution and removes a high-frequency component from the image using the periodicity of the arrangement of photoreceptor cells visualized on the image for preprocessing of the image, thus detecting photoreceptor cells automatically. The apparatus further measures the density of photoreceptor cells and the distance between photoreceptor cells based on the detection result of the photoreceptors for Voronoi analysis of its spatial distribution.

For the diagnosis or evaluation of a disease using the acquired image, it is important to shoot an image at an intended position in the fundus of the eye. Ophthalmic apparatuses are typically configured to find an image acquiring position roughly in the retina of the examinee who is asked to look fixedly at a fixation lamp presented. At this time, due to involuntary eye movement of the examinee, it is important for an operator to check whether the position actually shot agrees with the position presented with the fixation lamp or not. However an adaptive optics SLO has a narrower image acquiring area than that of a typical SLO, and so has difficulty for the operator to check whether the actually shot position agrees with the operator's intended position or not.

### SUMMARY OF THE INVENTION

In view of the above-stated problems, it is an object of the present invention to provide an image processing apparatus capable of checking the position of an image acquired by an adaptive optics SLO.

In order to solve the above-stated problems, an image processing apparatus according to the present invention processes an image of photoreceptor cells at a fundus of an eye to be inspected, and includes: a conversion unit to convert the image of the photoreceptor cells into an image indicating periodicity of the photoreceptor cells of the fundus; a characteristic amount acquiring unit to acquire a characteristic amount for the photoreceptor cells based on the image indicating the periodicity; and an estimating unit to estimate, based on the characteristic amount, a position where the image of the photoreceptor cells is acquired at the fundus.

The present invention enables estimation of a position where an image of photoreceptor cells is acquired at a fundus based on a characteristic amount (e.g., a physical amount corresponding to the density of the photoreceptor cells) relating to the photoreceptor cells. This allows an operator to check the position of the image of the photoreceptor cells actually acquired by the adaptive optics SLO.

Further features of the present invention will become apparent from the following description of exemplary embodiments with reference to the attached drawings.

### BRIEF DESCRIPTION OF THE DRAWINGS

FIG. 1 is a functional diagram of an image processing apparatus according to Embodiment 1.

FIG. 2 is a flowchart showing the processing procedure by the image processing apparatus according to Embodiment 1.

FIG. 3 schematically shows a high-definition planar image that is an image of photoreceptor cells shot by an adaptive optics SLO.

FIG. 4 shows an exemplary Fourier image that is acquired by frequency conversion of a planar image.

FIGS. 5A and 5B sequentially show a method to calculate a structure reflecting the arrangement of photoreceptor cells from a Fourier image.

FIG. 6 shows a relation between Fourier images and image acquiring positions with reference to the central fovea.

FIG. 7 shows a characteristic amount acquired based on a Fourier image.

FIG. 8 is a graph showing the relation between the ring structure of a Fourier image and the distance of the image acquiring position from the central fovea.

FIG. 9 is a flowchart to describe the estimation of an image acquiring position of FIG. 2 in details.

FIG. 10 is a functional diagram of an image processing apparatus according to Embodiment 2.

FIG. 11 is a flowchart showing the processing procedure by the image processing apparatus 10 according to Embodiment 2.

FIG. 12 shows an exemplary state where a planar image is divided into a plurality of local planar images.

FIG. 13 is a flowchart to describe the estimation of an image acquiring position of FIG. 11 in details.

FIG. 14 shows the relation between a characteristic amount of a local image and the image acquiring position.

### DESCRIPTION OF THE EMBODIMENTS

Preferred embodiments of the present invention will now be described in detail in accordance with the accompanying drawings.

An image processing apparatus according to the present embodiment includes a conversion unit that converts an image of photoreceptor cells at a fundus of an eye to be inspected into an image indicating periodicity of the photoreceptor cells. The conversion unit may be a frequency conversion portion, for example, to acquire a frequency image that is a frequency-converted image of photoreceptor cells at a fundus of an eye to be inspected. The frequency image refers to an exemplary image indicating the periodicity of photoreceptor cells. The present embodiment can use any method to acquire a periodic pattern of photoreceptor cells. For instance, an image indicating periodicity of photoreceptor cells may be acquired using a statistical characteristic of texture. The statistical characteristic of texture refers to a statistical property about the density distribution that a set of pixels has, which can be found by fractal analysis, calculation of the run length matrix, calculation of the cooccurrence matrix and the like.

The image processing apparatus according to the present embodiment further includes a characteristic amount acquiring unit to acquire a characteristic amount about photoreceptor cells from such an image indicating periodicity. Exemplary characteristic amounts about photoreceptor cells include a physical amount corresponding to the density of photoreceptor cells that is the highest at the central fovea and decreases with decreasing proximity to the central fovea, a physical amount associated with the intensity of a periodic structure of the photoreceptor cells, and a physical amount associated with distances between the photoreceptor cells. The characteristic amount in the present embodiment, for example, corresponds to a value that is the size of a ring structure appearing in an image obtained by discrete Fourier transform of a frequency spatial component of a planar image of the photoreceptor cells. The image processing apparatus according to the present embodiment further includes an estimating unit to estimate a position where the image of the photoreceptor cells is acquired at the fundus based on the characteristic amount. Based on the characteristic amount refers to based on a result obtained from a comparison of the magnitude relation of the acquired characteristic amounts, for example.

This enables checking whether the actually shooting position is a targeted position or not even when the shot image does not include a characteristic lesion or such a vascular structure.

An image of a retina shot by an adaptive optics SLO apparatus includes photoreceptor cells visualized thereon, in which a characteristic periodic structure of the arrangement of the photoreceptor cells appears. It is further known that the density of photoreceptor cells varies with a distance from a central fovea of the retina so that photoreceptor cells close to the central fovea are distributed densely and photoreceptor cells away from the central fovea are distributed sparsely. Based on such medical knowledge, the image acquiring position can be understood from how the photoreceptor cells imaged are arranged.

### Embodiment 1

The present embodiment describes processing to acquire an image of photoreceptor cells of a retina shot by an adaptive optics SLO, roughly estimate the distance of the image acquiring position from a central fovea based on the periodic structure of the photoreceptor cells in the acquired image, and present a relation with the position of a fixation lamp. The adaptive optics SLO corresponds to an image acquiring unit of the present invention to acquire a plurality of images of photoreceptor cells at different positions of the fundus. Specifically a planar mage of the fundus (hereinafter called a planar image) acquired by the adaptive optics SLO is subjected to discrete Fourier transform, thus acquiring a frequency spatial image thereof (hereinafter the thus acquired image is called a Fourier image). A characteristic amount of the periodic structure that reflects regular arrangement of the photoreceptor cells is extracted, i.e., acquired from the acquired Fourier image, and the distance of the image acquiring position from the central fovea is roughly estimated from the acquired characteristic amount. A comparison is made between the roughly estimated distance and an image acquiring position designated with the fixation lamp for evaluation whether the designated position is shot or not, and a result of the evaluation is presented.

Such presentation of information allows an operator to notice a failure in shooting of an intended position during the shooting when the examinee does not look at the presented fixation lamp, for example. This allows the operator to decide to reshoot, for example.

<Planar Image>

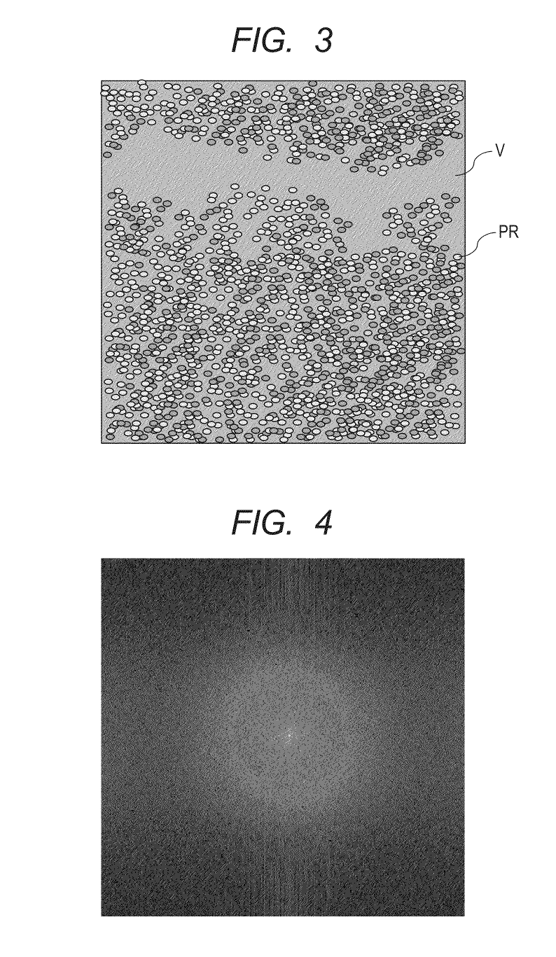

FIG. 3 schematically shows a planar image shot by an adaptive optics SLO. As shown in FIG. 3, each photoreceptor cell PR is visualized as a small area having relatively high brightness. A vessel area V may be visualized as an area having lower brightness than the brightness of photoreceptor cells. Such a vessel area represents the shadow of vessels existing at an upper layer of the photoreceptor cells. When the vessel area as shown in FIG. 3 is not included, photoreceptor cells PR are distributed uniformly on the entire image, which makes it difficult to find a shooting area from the image only.

<Fourier Image>

FIG. 4 schematically shows a Fourier image that is acquired by discrete Fourier transform of a frequency spatial component of the planar image. As shown in FIG. 4, there is a ring structure corresponding to the period of the photoreceptor cells, which reflects the periodic arrangement of the photoreceptor cells.

<Configuration of Image Processing Apparatus>

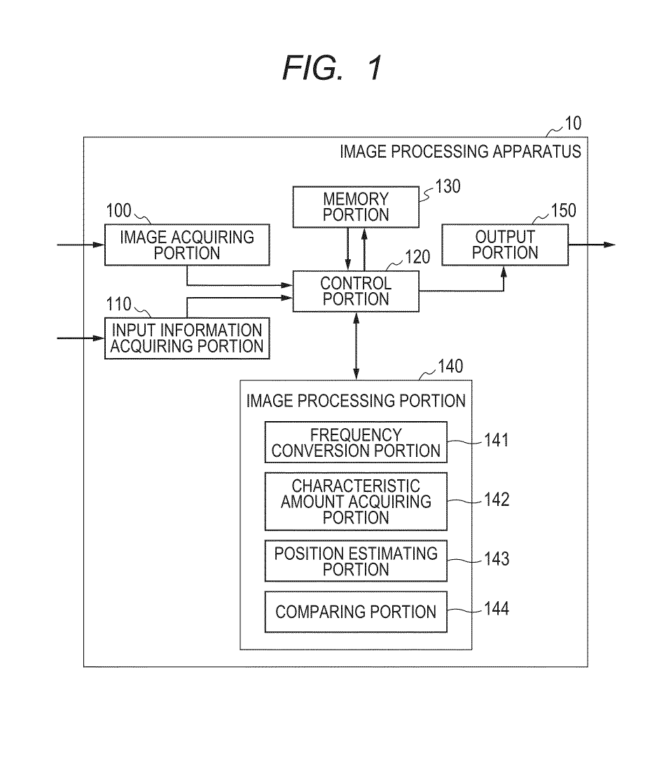

FIG. 1 is a functional diagram of an image processing apparatus 10 according to the present embodiment.

In FIG. 1, an image acquiring portion 100 acquires a planar image of a retina from an adaptive optics SLO apparatus. An input information acquiring portion 110 acquires information on an eye to be inspected at the time of shooting a planar image by the adaptive optics SLO. The acquired image is stored in a memory portion 130 via a control portion 120. An image processing portion 140 includes a frequency conversion portion 141, a characteristic amount acquiring portion 142, a position estimating portion 143, and a comparing portion 144. The image processing portion 140 generates a Fourier image from the acquired planar image, and estimates the distance of the image acquiring position from the central fovea based on a characteristic amount acquired from the Fourier image. The image processing portion 140 then compares the estimated image acquiring position with a fixation lamp presenting position stored in the memory portion 130 to evaluate whether the intended image acquiring position by the fixation lamp is shot or not. An output portion 150 outputs the result of the comparison between the estimated image acquiring position and the fixation lamp presenting position to a monitor or the like to present the same to an operator.

<Processing Procedure by Image Processing Apparatus>

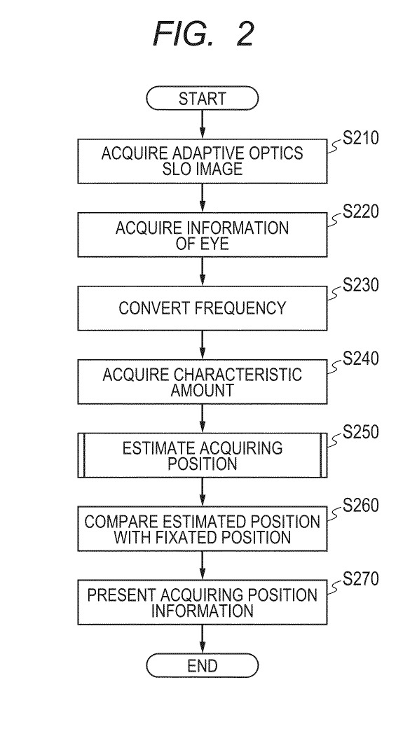

Referring to the flowchart of FIG. 2, the following describes processing procedure by the image processing apparatus 10 of the present embodiment.

<Step S210>

At Step S210, the image acquiring portion 100 acquires a shot planar image from an adaptive optics SLO connected to the image processing apparatus 10. The acquired planar image is stored in the memory portion 130 via the control portion 120.

At this time, the input information acquiring portion 110 acquires shooting parameter information at the time of shooting of the acquired planar image, and the information is stored in the memory portion 130 via the control portion 120. The shooting parameter information includes the position of a fixation lamp during shooting, for example. Such shooting parameter information including the position of a fixation lamp that is lit up at any fixation lamp presenting position may be described in an image shooting information file attached to the planar image or may be included as tag information of the image.

<Step S220>

At Step S220, the input information acquiring portion 110 acquires information on the eye to be inspected from a database or through the input by an operator using an inputting portion (not illustrated). The information on the eye to be inspected includes the ID of the patient whose eye is to be inspected, the name, the age, the sex, right eye or left eye as an examination target, a shooting date and time, and the like, and such acquired information is stored in the memory portion 130 via the control portion 120.

<Step S230>

At Step S230, the frequency conversion portion 141 performs discrete Fourier transform, i.e., frequency-converts the planar image acquired by the adaptive optics SLO and stored in the memory portion 130, and acquires a frequency spatial image thereof. As shown in FIG. 3, regularly arranged photoreceptor cells that are observed as small areas having high brightness occupy a large area of the planar image. This means that a Fourier image obtained by spatial frequency conversion of the planar image has a ring structure as shown in FIG. 4, whether the image partially includes or not an area of vessels, a lesion or the like.

<Step S240>

At Step S240, the characteristic acquiring portion or the characteristic amount acquiring portion 142 acquires, from the Fourier image acquired at Step S230, a characteristic amount indicating periodicity of the arrangement of the photoreceptor cells. Herein, the characteristic amount acquired shows the characteristic amount of the eye to be inspected based on the arrangement of its photoreceptor cells. The thus acquired characteristic amount is stored in the memory portion 130 via the control portion 120.

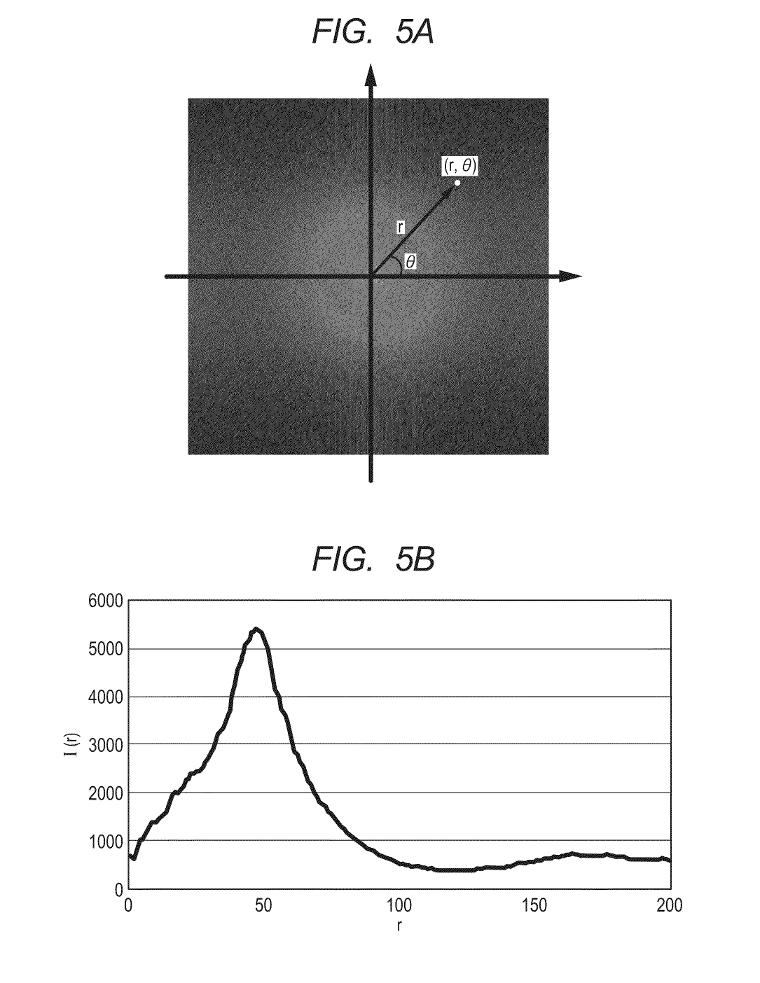

Specifically, as shown in FIG. 5A, letting that the Fourier image is a square having vertical and horizontal sizes of N×N, where N is the pixel number, polar coordinate representation (r, θ) having the origin at the center of the Fourier image represented as (N/2, N/2) is assumed. Then, a function I(r) to integrate the value of each pixel in the Fourier image in the 0 direction is calculated. Herein, r=0, 1, 2, . . . N/2. Since the Fourier image is not a continuous image but has a value for each pixel, I(r) is calculated by including the value of r for each pixel of 4.5 or more and less than 5.5 in the value of I(5), for example. Then an average value is calculated between adjacent points, for example, for smoothing of I(r). FIG. 5B shows the resultant function I(r) corresponding to FIG. 5A.

I(r) in FIG. 5B contains a lot of information on the arrangement of photoreceptor cells. Especially it is known that the density of photoreceptor cells reflects the distance from the central fovea and increases with increasing proximity to the central fovea and decreases with decreasing proximity to the central fovea. The ring-shaped structure appearing in the Fourier image reflects the density of photoreceptor cells, and so smaller density means a smaller radius of the ring. Based on this, the density of photoreceptor cells can be found by measuring the size of the ring in the Fourier image, and the distance from the central fovea can be roughly estimated from the density of photoreceptor cells.

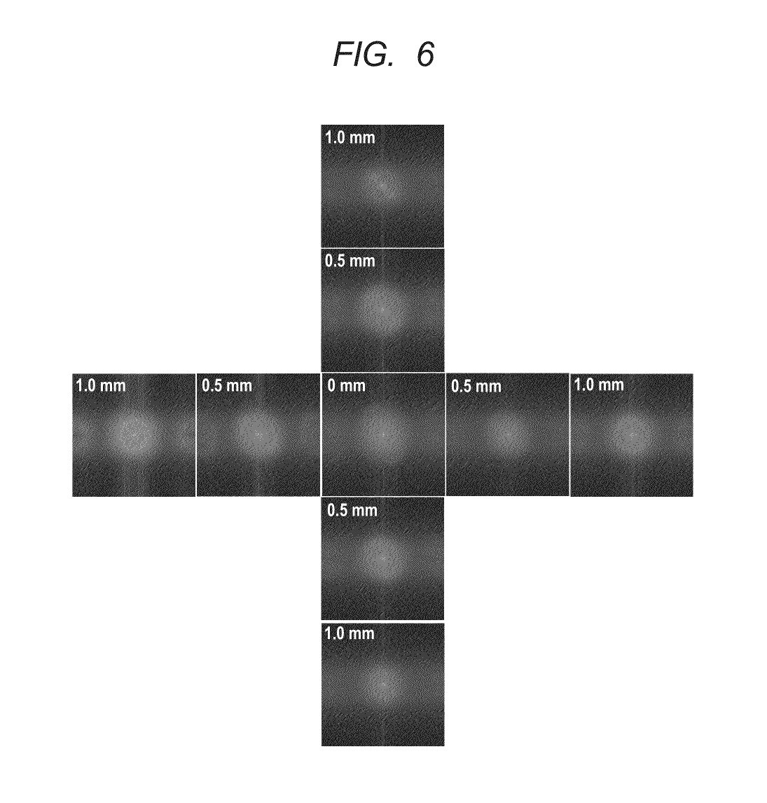

FIG. 6 shows Fourier images of the images that are shot at the central fovea, vertically and horizontally away from the central fovea by 0.5 mm and vertically and horizontally away from the central fovea by 1.0 mm. As shown in FIG. 6, as the distance from the central fovea increases, the ring in the Fourier image decreases in size. This reflects the clinical knowledge that the density of photoreceptor cells is the highest at a central fovea and decreases with decreasing proximity to the central fovea. That is, the present embodiment acquires a characteristic amount based on the size of the ring in an image showing a ring-shaped structure, and estimates that a smaller ring means a longer distance of an acquired position of an image corresponding to the characteristic amount from the central fovea.

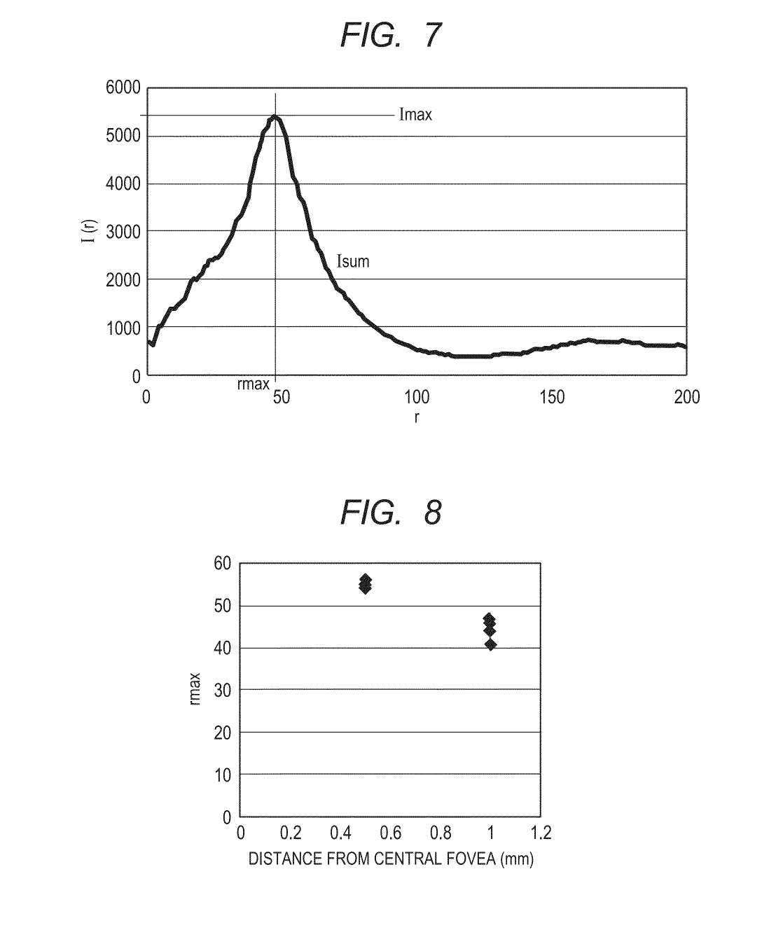

To acquire such a ring structure of the Fourier image, characteristic amounts as shown in FIG. 7 are acquired as characteristic amounts indicating the intensity of the periodic structure of photoreceptor cells. Specifically, a maximum value Imax of I(r) or an integrated value Isum of I(r) may be used.

$${I}_{max} = {max}_{r} I ( r )$$

$${I}_{sum} = {\sum }_{r}^{ } I ( r )$$

Then, rmax of r yielding Imax is a characteristic amount indicating the size of a ring structure, which is a characteristic amount corresponding to the magnitude of density of photoreceptor cells.

rₘₐₓ=argmaxI(r)

<Step S250>

At Step S250, the position estimating portion 143 calculates the distance of the shot image from the central fovea based on the characteristic amount acquired at Step S240. The thus calculated distance is stored in the memory portion 130 via the control portion 120. The following describes an exemplary method to calculate a distance based on the characteristic amount acquired at Step S240, and the calculation method is not limited to the following example.

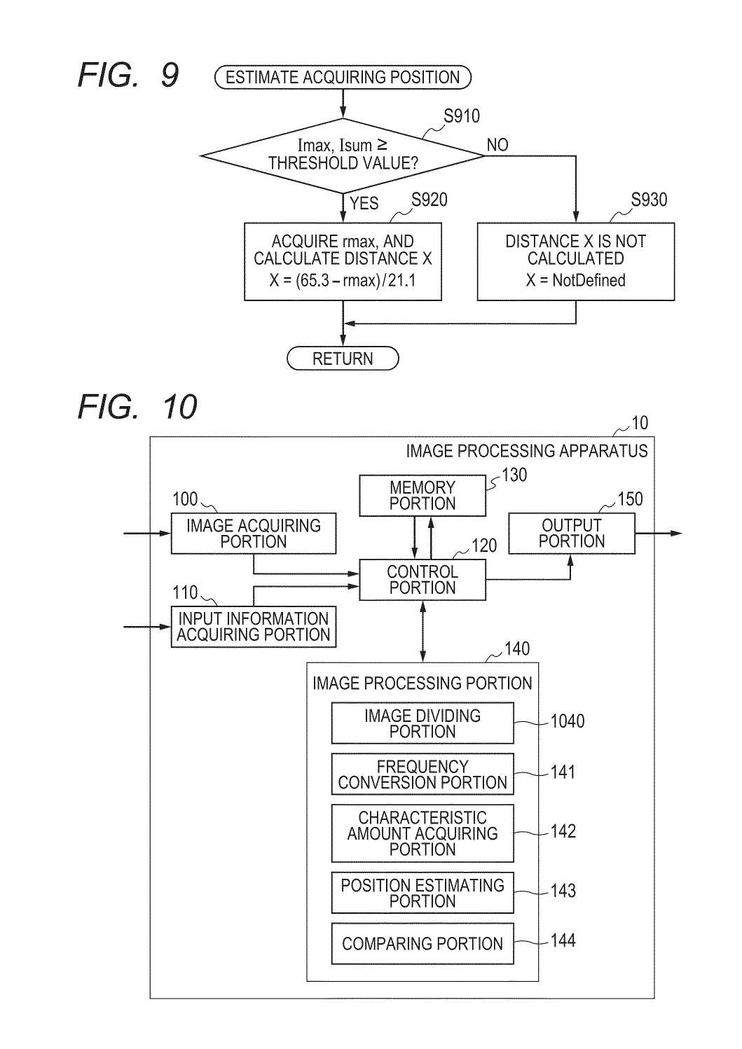

FIG. 9 is a flowchart to describe the estimation of the image acquiring position in details.

<Step S910>

At Step S910, the position estimating portion 143 determines whether the image acquiring position of the shot image can be estimated or not from Imax and Isum that are the characteristic amounts acquired at Step S240. Among a plurality of characteristic amounts acquired at Step S240, Imax and Isum relate to the intensity of the periodic structure of photoreceptor cells, and rmax relates to the density of photoreceptor cells or the distance between photoreceptor cells.

Herein, the calculation of rmax requires at least a ring structure of photoreceptor cells visualized on the planar image. If no photoreceptor cells are visualized there due to poor image quality resulting from a condition of the planar image acquisition, a problem occurs in reliability of the roughly estimated value of the distance. Then, certain thresholds are set for the values of Imax and Isum, and only when they are the thresholds or more, the procedure goes to Step S920 for rough estimation of the distance. When the values of Imax and Isum are their thresholds or less, a rough estimated value of the distance cannot be acquired (NotDefined) (Step S930). Imax and Isum have their thresholds set at 1,000 and 100,000, respectively, in this example.

<Step S920>

At Step S920, the position estimating portion 143 estimates the distance from the central fovea as the image acquiring position of the shot image based on rmax that is a characteristic amount acquired at Step S240.

FIG. 8 is a graph showing the relation between the distance from the central fovea and rmax of the image shown in FIG. 6. As shown with the Fourier image in FIG. 6, the use of the characteristic amount of rmax shows that decreasing the proximity to the central fovea means a smaller ring. The following first-order approximation can be found from the graph of FIG. 8.

rₘₐₓ=−21.1x+65.3

In this expression, x denotes a distance from the central fovea. Then the spatial frequency of photoreceptor cells can be found as 54.8 and 44.2 at the distance x of 0.5 mm and 1.0 mm, respectively, from the central fovea, and letting that the image has a pixel size of 400×400 and the actual size of 340 μm×340 μm, the distances between photoreceptor cells found are 6.2 μm and 7.7 μm, respectively. This result is consistent with the roughly estimated values of the density of photoreceptor cells that are obtained from the previous research, i.e., 30,000 photoreceptor cells/mm² at 0.5 mm from the central fovea and 15,000 photoreceptor cells/mm² at 1.0 mm.

Therefore using the above first-order approximation, the distance x from the central fovea can be estimated based on rmax as a characteristic amount obtained from the Fourier image as follows.

$$x = \frac{65.3 - {r}_{max}}{21.1}$$

FIG. 8 does not show the value of rmax at the central fovea. This is because the adaptive optics SLO shooting the planar image group shown in FIG. 6 cannot resolve the photoreceptor cells in the vicinity of the central fovea. In such a case of failing in resolving, Imax and Isum do not reach the values of thresholds, thus meaning NotDefined in the above flowchart of FIG. 9.

The thus acquired estimated value of the distance is stored in the memory portion 130 via the control portion 120.

<Step S260>

At Step S260, the comparing portion 144 acquires a fixated position stored in the memory portion 130. Then the comparing portion 144 compares the estimated value of the distance from the central fovea acquired at Step S250, i.e., the estimated image acquiring position and the fixation lamp presenting position during image shooting as the acquired fixated position.

Let that the central fovea and the shot planar image have coordinates on a fixation map indicating the fixated position of (45, 43) and (45, 34), respectively. Letting that one step of the coordinates on the fixation map is about 0.056 mm, then the distance of the planar image from the central fovea is 9×0.056=0.504 mm. Letting further that this planar image has rmax of 54.5, then the distance x estimated at Step S250 is 0.509 mm. In this way, when the estimated value of the distance acquired at Step S240 and the distance from the central fovea found from the fixated position of the planar image are at the same level, the comparison result therebetween becomes Reasonable. Conversely, when these two distances have values at different levels, the comparison result becomes Unreasonable. When the roughly estimated value of the distance at Step S250 is NotDefined, the comparison result also becomes NotDefined. Such procedure is performed by a configuration functioning as a determining portion as a determining unit, which is in association with the comparing portion 144 as a comparing unit to determine whether the estimated image acquiring position is correct or not based on the comparison between the image acquiring position and the fixation lamp presenting position.

The two distances are determined as at the same level when the distance estimated at Step S250 is within ±10% of the distance found from the fixated position of the planar image. This range may be set in various ways, and the method used in the present embodiment is not a limiting one. Such a determination is based on whether the difference between the estimated image acquiring position and the fixation lamp presenting position is within a predetermined range or not, and this predetermined range (in this example, ±10%) is stored beforehand in the memory portion 130, which may be changed appropriately as a comparison standard by the comparing portion 144 as needed for use.

For instance, this range may be changed based on whether correction is performed or not considering the eye axial length. A typical axial length is 24 mm, which varies from person to person by about ±2 mm, for example. The scanning range of the measuring light changes with this axial length, and so the aforementioned estimated values or the like preferably are subjected to correction depending on this axial length. When correction is performed considering the axial length of the eye to be examined, the estimated value is in accordance with the axial length of the eye to be examined, and so the determination standard can be within ±10% similarly to the above. On the other hand, when such correction is not performed because the value of the axial length cannot be acquired during shooting, for example, the estimated value presented includes influences of individual differences of the axial length. Then, the value within ±20% may be determined as Reasonable. In this way, validity of the comparison result can be presented, for example.

The thus acquired comparison result is stored in the memory portion 130 via the control portion 120.

<Step S270>

At Step S270, the output portion 150 acquires the estimated value of the distance of the image acquiring position from the central fovea that is stored in the memory portion at Step S250 and the comparison result stored in the memory portion at Step S260, and displays them on a monitor, for example, to present them to the operator. Especially when the estimated value of the image acquiring position of the actually shot planar image is different from the image acquiring position designated as the fixated position, the output portion 150 issues a warning to the operator as such.

Specifically, when the comparison result is Unreasonable, the estimated position of the image acquiring position of the shot image is shown on the fixation map used for shooting, and then a warning message is shown.

In the present embodiment, the estimated shooting position is displayed at a display such as a monitor. Alternatively, such displaying may be performed via a display control unit that is configured to output data or the like of the shooting position to another memory unit or display unit. That is, in a preferable mode, the display control unit selects a preferable display form of the estimated position from a memory unit or the like, and makes the display unit display or execute the same.

With this configuration, when the position of a planar image of photoreceptor cells at a retina that is shot by an adaptive optics SLO apparatus is expected to be different from the image acquiring position designated by the fixated position, a warning message together with the estimated image acquiring position can be presented. This allows an operator to notice an error of the shooting position during shooting, and to deal with the situation by reshooting, for example.

Further, evaluation is performed as to whether the estimated image acquiring position agrees or not with the position presented with the fixation lamp and a result of the evaluation is presented to the operator, thus providing support for shooting to the operator.

### Embodiment 2

In Embodiment 1, the entire planar image acquired by an adaptive optics SLO is frequency-converted to find a Fourier image thereof, from which characteristic amounts relating to the ring structure reflecting the periodic structure of photoreceptor cells are acquired, and the distance of the shot planar image from the central fovea is roughly estimated. Then evaluation is performed as to whether this distance agrees with the distance from the central fovea that is designated with a fixation lamp or not, whereby an error in the image acquiring position, if any, can be presented to the operator.

The method of Embodiment 1, however, can evaluate the distance from the central fovea only, and cannot evaluate the direction thereof. Specifically, if a part at 1.0 mm below the central fovea instead of at 1.0 mm above the central fovea is erroneously shot, such an error of the image acquiring position cannot be presented only based on the estimated value of the distance because they are different in direction but the same in distance.

To evaluate not only the distance from the central fovea but also the direction thereof, the present embodiment describes the case of dividing a planar image into a plurality of local areas and finding a Fourier image of each of the divided planar images, thus analyzing the image using characteristic amounts acquired therefrom.

FIG. 10 is a functional diagram of an image processing apparatus 10 of the present embodiment. Since this image processing apparatus includes portions 100 to 150 having the same configuration as those of FIG. 1, their descriptions are omitted. An image processing portion 140 of the present embodiment includes an image dividing portion 1040 in addition to a frequency conversion portion 141, a characteristic amount acquiring portion 142, a position estimating portion 143 and a comparing portion 144, and is configured to divide a planar image into a plurality of areas and acquire characteristic amounts for each area, and then combine them, thus evaluating the distance and the direction from the central fovea. The image dividing portion 1040 corresponds to an image dividing unit of the present invention to divide an image of photoreceptor cells into a plurality of areas.

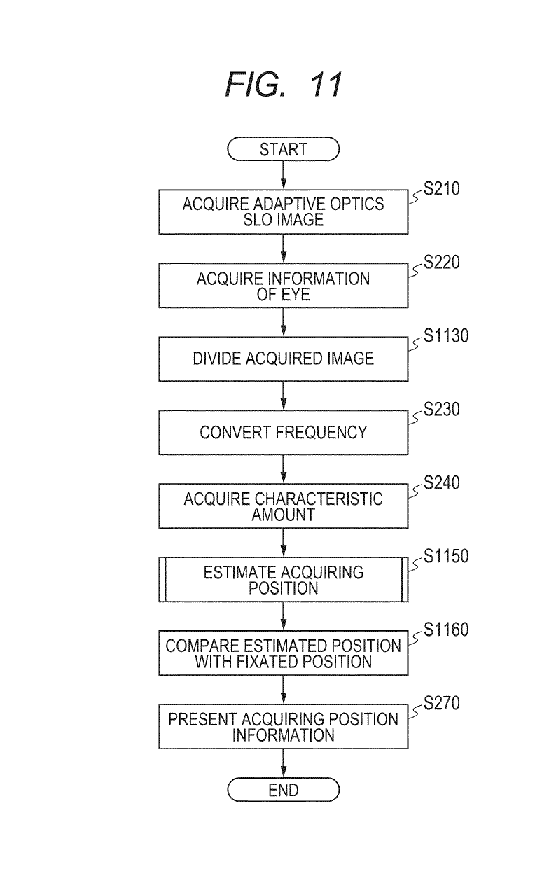

Referring to the flowchart of FIG. 11, the following describes the processing procedure by the image processing apparatus 10 of the present embodiment. Since Steps S210, S220, S230, S240 and S270 are the same as in the procedure of Embodiment 1, their descriptions are omitted.

In Embodiment 1, a distance from the central fovea is estimated for the entire planar image acquired by an adaptive optics SLO. The present embodiment is different from Embodiment 1 in that a planar image is divided into a plurality of local planar images, characteristic amounts are calculated for each area, and the characteristic amounts calculated are combined for evaluation of the image acquiring position of the entire image. That is, images processed at Steps S230 and S240 are divided local planar images.

The following is a detailed description for each step.

<Step S1130>

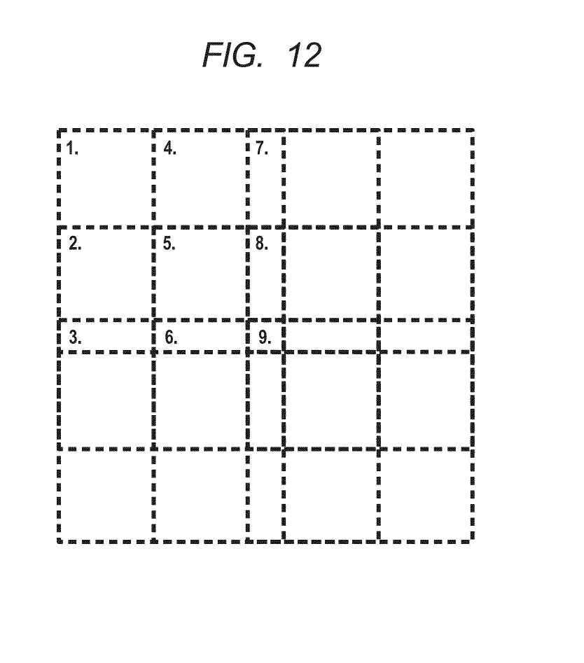

At Step S1130, the image dividing portion 1040 acquires a planar image acquired by an adaptive optics SLO that is stored in the memory portion 130, and divides the same into a plurality of local planar images. The division may be performed in various ways. A local difference can be clarified more from more images divided, but accuracy of information obtained from each local planar image becomes lower. The cost for processing time also is required for frequency conversion of a plurality of local planar images, and so it is also important to use the size of the n-the power of 2 that is an image size suitable for high-speed Fourier transform. For instance, a local planar image of 256×256 in pixel size is acquired from an original planar image of 400×400 while permitting the overlapping as shown in FIG. 12. Specifically, a local planar image sharing the upper left corner with the planar image is 1, and local planar images moving downward in parallel are 2, 3. A local planar image horizontally moving to the left from the mage 1 in parallel is 4, and then images moving downward therefrom in parallel are 5, 6. Similarly, local planar images 7, 8 and 9 are defined, so that one planar image of 400×400 is divided into nine local planar images of 256×256. The dividing method is not limited to this.

The thus prepared nine local planar images are stored in the memory portion 130 via the control portion 120. The following processing at Steps S230 and S240 are the same as those of Embodiment 1, and the processing is performed for each of the nine local planar images prepared at Step S1130, through which characteristic amounts for each image are acquired. The acquired characteristic amounts in association with the corresponding local planar image are stored in the memory portion 130.

<Step S1150>

At Step S1150, the position estimating portion 143 estimates the distance of a local planar image from the central fovea based on a characteristic amount acquired from the local planar image. The position estimating portion 143 further estimates the image acquiring position of the planar image based on the estimated values of the local planar images from the central fovea.

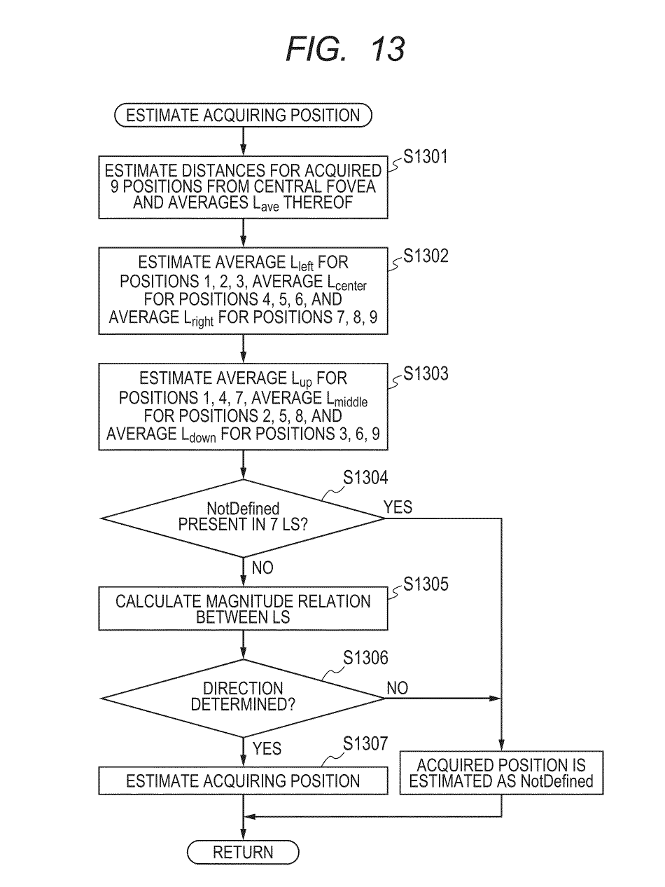

FIG. 13 is a flowchart to estimate an image acquiring position of a planar image using characteristic amounts acquired from the nine local planar images divided at Step S1130.

<Step S1301>

At Step S1301, the position estimating portion 143 estimates a distance of each of the local planar images at nine positions from the central fovea based on a characteristic amount acquired from each local planar image. Since the distance is estimated by the same method as described in Step S250, their descriptions are omitted.

Then, the average Lave of the found estimated values of the distances corresponding to the nine local planar images is found.

<Step S1302>

At Step S1302, the position estimating portion 143 finds a left-side average Lleft, a central average Lcenter and a right-side average Lright of the estimated values of the distances from the central fovea acquired from the nine local planar images. Herein the left-side average is an average of the estimated values of the distances of the local images 1, 2 and 3 of FIG. 12, the central average is similarly an average of the local images 4, 5 and 6 and the right-side average is an average of the local images 7, 8 and 9. When the estimated values of the distances for the local images include NotDefined, the average is calculated by excluding the corresponding local image. When all of the estimated values of the distances from three images are NotDefined, the average of the distances becomes NotDefined.

<Step S1303>

At Step S1303, the position estimating portion 143 finds an upper average Lup, a central average Lmiddle and a lower average Ldown of the estimated values of the distances of nine local planar images from the central fovea. Herein the upper average is an average of the estimated values of the distances of the local images 1, 4 and 7 of FIG. 12, the central average is similarly an average of the local images 2, 5 and 8 and the lower average is an average of the local images 3, 6 and 9. When the estimated values of the distances for the local images include NotDefined, the average is calculated by excluding the corresponding local image. When all of the estimated values of the distances from three images are NotDefined, the average of the distances becomes NotDefined.

<Step S1304>

At Step S1304, the position estimating portion 143 determines whether the averages of the distance estimated values found at Steps S1301 to S1303 include NotDefined or not. If any one of the seven averages includes NotDefined, the estimated value of the image acquiring position for the planar image also becomes NotDefined.

<STEP S1305>

At Step S1305, the position estimating portion 143 calculates a magnitude relation among the averages of the distance estimated values found at Steps S1301 to S1303. Specifically, a magnitude relation among Lleft, Lcenter and Lright and a magnitude relation among Lup, Lmiddle and Ldown are found.

<Step S1306>

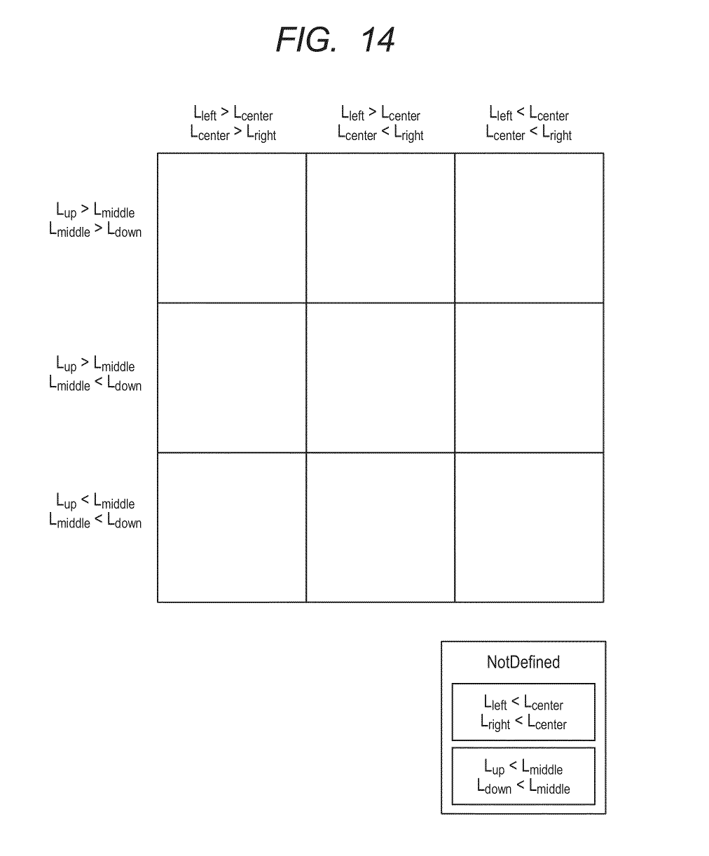

At Step S1306, the position estimating portion 143 finds the direction of shifting of the shot image from the central fovea based on the magnitude relations found at Step S1305. Specifically as shown in FIG. 14, when Lleft>Lcenter and Lcenter>Lright, the direction is the left-side of the central fovea, and when Lleft<Lcenter and Lcenter<Lright, the direction is the right-side of the central fovea. Similarly, when Lup>Lmiddle and Lmiddle>Ldown, the direction is the upper-side of the central fovea, and when Lup<Lmiddle and Lmiddle<Ldown, the direction is the lower-side of the central fovea. When Lleft<Lcenter and Lright<Lcenter or when Lup<Lmiddle and Ldown<Lmiddle, the direction of shifting cannot be found, and so the estimated value of the image acquiring position becomes NotDefined.

<Step S1307>

At Step S1307, the position estimating portion 143 estimates the image acquiring position based on the average Lave of the estimated values of the distances at the nine local planar images found at Step S1301 and the direction of shifting from the central fovea found at Step S1306. Herein the value of Lave is presented as the estimated value of the distance, and any of nine divided areas shown in FIG. 14 is presented as the image acquiring position.

<Step S1160>

At Step S1160, the comparing portion 144 acquires the fixated position stored in the memory portion 130. Then, the comparing portion 144 compares the estimated value of the image acquiring position acquired at Step S1150 and the acquired fixated position.

The comparison of distances is performed in the same method as described in Step S260. The direction is compared between the direction found at Step S1306 and the direction corresponding to the fixated position, where the comparison is performed for the nine divisions shown in FIG. 14 as to whether these directions agree or not. When they do not agree, the comparison result becomes Unreasonable.

As described above, the image processing apparatus of the present embodiment includes an image dividing portion that divides an image into a plurality of areas. Then the frequency conversion portion performs frequency conversion of each of the divided images, and the characteristic amount acquiring portion acquires a characteristic amount from each of the divided images. The position estimating portion or the estimating portion estimates an image acquiring position for each divided image based on the characteristic amount thereof.

With this configuration, a planar image acquired by an adaptive optics SLO apparatus is divided into a plurality of local areas, and estimated values of distances of the local planar images are combined, whereby the image acquiring position of the planar image can be estimated. Then evaluation is performed during shooting as to whether the estimated image acquiring position agrees or not with the image acquiring position presented with a fixation lamp, and a result of the evaluation is presented to the operator. Thereby, if a position different from the intended position of the operator is shot because the examinee cannot look the fixation lamp fixedly, for example, the operator can understand such a situation. Then, the estimated image acquiring position is presented and a warning message is presented when the estimated image acquiring position does not agree with the image acquiring position corresponding to the fixated position during shooting. This allows the operator to deal with the situation by reshooting, for example.

### Other Embodiments

Needless to say, the object of the present invention can be fulfilled also by supplying a storage medium storing a program code of software implementing the functions of the aforementioned embodiments to a system or an apparatus and by letting a computer (or a CPU or a MPU) of the system or the apparatus read and execute the program code stored in the storage medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-288357, filed Dec. 28, 2012, which is hereby incorporated by reference herein in its entirety.

What is claimed is:

1. An image processing apparatus that processes an image of photoreceptor cells at a fundus of an eye to be inspected, comprising:
a conversion unit to convert the image of the photoreceptor cells into an image indicating periodicity of the photoreceptor cells of the fundus;
a characteristic amount acquiring unit to acquire a characteristic amount for the photoreceptor cells based on the image indicating the periodicity; and
an estimating unit to estimate, based on the characteristic amount, a position where the image of the photoreceptor cells is acquired at the fundus.

2. The image processing apparatus according to claim 1, further comprising an image acquiring unit to acquire a plurality of images of photoreceptor cells at different positions of the fundus, wherein
the conversion unit converts the plurality of images of photoreceptor cells into a plurality of images indicating periodicity of the photoreceptor cells, and
the characteristic amount acquiring unit acquires a plurality of characteristic amounts for the photoreceptor cells based on the plurality of images indicating the periodicity.

3. The image processing apparatus according to claim 2, wherein the estimating unit estimates a position where each of the plurality of images of the photoreceptor cells is acquired based on a magnitude relation of the plurality of characteristic amounts.

4. The image processing apparatus according to claim 3, wherein the estimating unit estimates a position where an image of the photoreceptor cells corresponding to a maximum characteristic amount of the plurality of characteristic amounts is acquired is estimated as a central fovea at the fundus.

5. The image processing apparatus according to claim 4, wherein the estimating unit compares a characteristic amount other than the maximum characteristic amount of the plurality of characteristic amounts with the maximum characteristic amount to estimate a distance between a position where an image of the photoreceptor cells corresponding to the characteristic amount other than the maximum characteristic amount is acquired and the central fovea.

6. The image processing apparatus according to claim 1, wherein the conversion unit frequency-converts the image of the photoreceptor cells to acquire the image indicating the periodicity.

7. The image processing apparatus according to claim 1, wherein
the conversion unit acquires an image showing a ring-shaped structure as the image indicating the periodicity, and the characteristic amount acquiring unit acquires the characteristic amount based on a size of the ring, and
the estimating unit estimates that a smaller size of the ring means a longer distance of an acquired position of an image corresponding to the characteristic amount from the central fovea.

8. The image processing apparatus according to claim 1, wherein the characteristic amount acquiring unit acquires the characteristic amount based on arrangement of the photoreceptor cells at the fundus.

9. The image processing apparatus according to claim 1, further comprising a display control unit that makes a display unit display a display form indicating the estimated position.

10. The image processing apparatus according to claim 1, further comprising:
a fixation lamp that is lit up at any fixation lamp presenting position for vision fixation of the eye to be inspected;
a comparing unit to compare the estimated position with the fixation lamp presenting position when the image of the photoreceptor cells is acquired; and
a determining unit to determine whether the estimated position is correct or not based on a result of the comparison by the comparing unit.

11. The image processing apparatus according to claim 10, wherein the determining unit determines whether a difference between the estimated position and the fixation lamp presenting position is within a predetermined range or not, thus determining whether the estimated position is correct or not.

12. The image processing apparatus according to claim 11, wherein the comparing unit changes the predetermined range based on whether correction of the estimated image acquiring position is performed or not based on an axial length of the eye to be inspected.

13. The image processing apparatus according to claim 1, further comprising an image dividing unit to divide the image of the photoreceptor cells into a plurality of areas, wherein
the conversion unit performs frequency conversion for each of the plurality of areas,
the characteristic amount acquiring unit acquires the characteristic amount from each of the plurality of areas, and
the estimating unit estimates a position where the image of the photoreceptor cells is acquired for each of the plurality of areas based on the corresponding characteristic amount.

14. An image processing method that processes an image of photoreceptor cells at a fundus of an eye to be inspected, comprising the steps of:
converting the image of the photoreceptor cells into an image indicating periodicity of the photoreceptor cells of the fundus;
acquiring a characteristic amount for the photoreceptor cells based on the image indicating the periodicity; and
estimating, based on the characteristic amount, a position where the image of the photoreceptor cells is acquired at the fundus.

15. The image processing method according to claim 14, further comprising the step of acquiring a plurality of images of photoreceptor cells at different positions of the fundus, wherein
the converting step converts the plurality of images of photoreceptor cells into a plurality of images indicating periodicity of the photoreceptor cells, and
the acquiring step acquires a plurality of characteristic amounts for the photoreceptor cells based on the plurality of images indicating the periodicity.

16. The image processing method according to claim 15, wherein the estimating step estimates a position where each of the plurality of images of the photoreceptor cells is acquired based on a magnitude relation of the plurality of characteristic amounts.

17. The image processing method according to claim 14, wherein the conversion step frequency-converts the image of the photoreceptor cells to acquire the image indicating the periodicity.

18. The image processing method according to claim 14, wherein the acquiring step acquires the characteristic amount based on arrangement of the photoreceptor cells at the fundus.

19. The image processing method according to claim 14, further comprising the step of making a display unit display a display form indicating the estimated position.

20. A program that makes a computer execute the steps of the image processing method according to claim 14.
